(19) United States
(12) Patent Application Publication
(10) Pub. No.: US 2023/0084278 A1
(43) Pub. Date: Mar. 16, 2023

(54) SYSTEM AND METHOD FOR HYPERGRAPH-BASED MULTI-AGENT BATTLEFIELD SITUATION AWARENESS

(71) Applicant: ELECTRONICS AND TELECOMMUNICATIONS RESEARCH INSTITUTE, Daejeon (KR)

(72) Inventor: Jaeuk BAEK, Gwangju (KR)

(73) Assignee: ELECTRONICS AND TELECOMMUNICATIONS RESEARCH INSTITUTE, Daejeon (KR)

(21) Appl. No.: 17/675,990

(22) Filed: Feb. 18, 2022

(30) Foreign Application Priority Data
Sep. 3, 2021 (KR) 10-2021-0117882

(51) Int. Cl. G06N 5/02; G06N 5/04; G06F 17/16

(52) U.S. Cl. CPC G06N 5/022; G06N 5/043; G06F 17/16

(57) ABSTRACT

The present invention relates to a system and method for hypergraph-based multi-agent battlefield situation awareness. The system for hypergraph-based multi-agent battlefield situation awareness according to the present invention includes a knowledge graph generation unit configured to receive pieces of data collected by agents as an input and generate agent knowledge graphs including nodes, relations, and node embedding vectors for each agent, a knowledge graph concatenation unit configured to analyze a similarity between the respective agents and a similarity between the pieces of data and concatenate the plurality of agent knowledge graphs to generate a global knowledge graph, and a battlefield situation awareness unit configured to infer a battlefield situation using a battlefield situation hierarchical structure and the global knowledge graph.

### CROSS-REFERENCE TO RELATED APPLICATION

This application claims priority to and the benefit of Korean Patent Application No. 10-2021-0117882, filed on Sep. 3, 2021, the disclosure of which is incorporated herein by reference in its entirety.

### BACKGROUND

### 1. Field of the Invention

The present invention relates to a system and method for hypergraph-based multi-agent battlefield situation awareness that classify agents placed in the same battlefield situation using multi-modal data (for example, visual, voice, language, graph, etc.) collected by each agent and infers the battlefield situation through an analysis of a similarity between pieces of information acquired by the agents. A deep learning network proposed in the present invention is an unsupervised learning system that provides agent embedding vectors representing characteristics of agents by using data or meta-information collected by the agents without a label for similarity between the agents. More particularly, the present invention relates to a system and method for hypergraph-based multi-agent battlefield situation awareness capable of supporting global battlefield environment awareness, threat judgment, and command decision of commanders by inferring the battlefield situation without being limited due to types, amounts, characteristics, or the like of data collected by multiple manned/unmanned agents in future combat environment where the agents, such as warrior platforms, drones, and robots, are expected to play an active role.

### 2. Discussion of Related Art

In order to infer a battlefield situation from multi-modal data collected by agents and meta-information corresponding to the multi-modal data, a scene graph, and a knowledge graph, there is a need to classify agents placed in the same battlefield situation and analyze a similarity of information acquired by the agents. As the existing technologies for training agent embedding vectors to infer a similarity between agents, there are a graph neural network and clustering. The graph neural network performs training so that embedding vectors between adjacent nodes according to a graph structure become similar. Therefore, when a graph neural network is used in a multi-agent embedding system, the embedding vector of nodes (or features) constructing data collected by agents can be expressed, but there is a limit to obtaining embedding vectors representing agents themselves including several nodes and graphs. Although it is possible to obtain an agent embedding vector through post-processing such as graph convolution and vector concatenation, it is difficult to apply data collected by multiple agents to a battlefield situation that changes over time.

As a clustering method to find agents with a high similarity, there are a method of analyzing similarity through exhaustive search on data collected by agents, and a method of selecting k similar agents through a k-means algorithm. However, these methods not only have very high computational complexity, but also have limitations in that clustering needs to be repeatedly performed when a new agent is added or amounts, types, and characteristics of data acquired by the agents change.

In addition, the related art, which is not an end-to-end multi-agent embedding system, has limitations in speed and accuracy in determining similarity between agents and inferring battlefield situations. Therefore, there is a problem in that the related art is difficult to actually utilize in regiment/division/corps-level battlefield situation awareness that processes information collected by numerous agents and in the future combat environment in which manned/unmanned agents play an active role.

### SUMMARY OF THE INVENTION

The present invention is directed to providing a deep learning network that classifies agents placed in the same battlefield situation by using data (visual, voice, language, graph, etc.) or meta-information collected by the agents without a label for similarity between the agents, and infers a battlefield situation through an analysis of the similarity of information acquired by the agents. An object of the present invention is to provide a hypergraph-based multi-agent embedding system and method capable of supporting global battlefield environment awareness, threat judgment, and command decision of a commander.

According to an aspect the present invention, a system for hypergraph-based multi-agent battlefield situation awareness includes a knowledge graph generation unit configured to receive pieces of data collected by each agent as an input and generate agent knowledge graphs including nodes, relations, and node embedding vectors for each agent, a knowledge graph concatenation unit configured to analyze a similarity between the respective agents and a similarity between the pieces of data and concatenate the plurality of agent knowledge graphs to generate a global knowledge graph, and a battlefield situation awareness unit configured to infer a battlefield situation using a battlefield situation hierarchical structure and the global knowledge graph.

The knowledge graph generation unit may define an object, which is recognized from the data collected by the agent, as the node to generate a node list, define features of the respective nodes as a property to generate a property list, and define a predetermined relation between the nodes as the relation to generate a relation list.

The knowledge graph generation unit may generate the node embedding vector by concatenating an embedding vector (vec1) related to the property of the node, an embedding vector (vec2) in which a node name is defined, and an embedding vector (vec3) related to the relation between the nodes, train the embedding vector (vec1) so that the embedding vector (vec1) is similar to a property vector directly related to each of the nodes and dissimilar to a property vector not related to each of the nodes, and train the embedding vector (vec3) so that embedding vectors (vec3) of the nodes having the relation to each other become similar.

The knowledge graph concatenation unit may construct an incidence matrix in a way to select an agent adjacent to a node of a specific agent knowledge graph, and the adjacent agent may include a node having a node embedding vector similar to the node embedding vector of the node as a component of the agent knowledge graph.

The knowledge graph concatenation unit may include a hypergraph-based random sample module configured to generate a hypergraph including hypernodes corresponding to each of the agents and hyperedges representing a set of adjacent agents of each of the nodes, and generate an agent list based on the hypergraph, an agent embedding learning module configured to derive an (agent, adjacent agent) pair by applying a context window to the agent list, and train the agent embedding vector so that a value of a cost function calculated from the (agent, adjacent agent) pair is minimized, and a similarity inference and concatenation module configured to generate the global knowledge graph by concatenating each agent knowledge graph through the analysis of the similarity between the agents using the agent embedding vector and an analysis of a similarity between data of a specific agent and data collected by an agent adjacent to the specific agent using the agent embedding vector.

The hypergraph-based random sample module may generate a hyperedge including a plurality of agents based on a similarity between the node embedding vectors assigned to each node of the agent knowledge graph and a node embedding vector of another agent knowledge graph, and generate a hypergraph including the hyperedge and a hypernode corresponding to an agent included in the hyperedge.

The hypergraph-based random sample module may generate the agent list in a way to move an arbitrary agent according to a random walk rule based on the hypergraph, and the random walk rule may define a movement probability from a current agent to a next agent and include a rule for determining the movement probability according to the number of hyperedges included in the hypergraph shared by an agent adjacent to the current agent and a previously visited agent.

The cost function may be defined for the (agent, adjacent agent) pair (i,j) according to the following Equation.

$$Cost ( e \vert {e}_{j} , {ψ}_{f} ) = - ( log σ ( {f}_{k} ( {e}_{i} ) \cdot {f}_{i} ( {e}_{j} ) - {c}_{k l} ) + {\sum }_{m ∈ {Ψ}_{f}} {\sum }_{v ∈ {Ψ}_{a}} log σ ( - {f}_{m} ( {e}_{v} ) \cdot {f}_{l} ( {e}_{j} ) + {c}_{ml} ) ) \qquad [ Equation ]$$

(Here, in the above Equation, i,j, and v denote the agents,

k, l, and m denote nodes constructing the agent knowledge graph,

eᵢ, eⱼ, and eᵥ denote the agent embedding vectors,

uₖ, uₗ, and uₘ denote the fixed vectors (relation aware vector) assigned to the node,

c denotes a dot product of the relation aware vectors of each of the nodes written in a subscript,

Ψₐ denotes a set of agents, and Ψ_{f} denotes a set of nodes constructing the agent knowledge graph,

σ denotes a sigmoid function, and

f denotes a vector function that returns a sum of the relation aware vector of the node written in the subscript and the agent embedding vector as an argument).

The relation aware vector for an arbitrary knowledge graph node k may be defined as uₖ=[u_{k,1}, u_{k,2}, . . . , u_{k,2n-1}, u_{k,2n}, . . . , u_{k,d}_{_{vec}}]^{T}, and

an arbitrary factor of uₖ may be defined as

$${u}_{k , 2 n - 1} = cos ( {( \frac{k}{\vert {Ψ}_{f} \vert} )}^{\frac{2 n - 1}{{d}_{vec}}} ) , {u}_{k , 2 n} = sin ( {( \frac{k}{\vert {Ψ}_{f} \vert} )}^{\frac{2 n - 1}{{d}_{vec}}} ) , for n = 1 , 2 , … .$$

(Here, in the above Equation, d_{vec} denotes a dimension of uₖ).

The relation aware vector for an arbitrary knowledge graph node k may be obtained by uₖ·uₗ=0 for k≠l with ∥uₖ∥=∥uₗ∥=1, k, lεΨ_{f}.

The battlefield situation awareness unit may define the battlefield situation as a hierarchical structure composed of a higher concept and a lower concept, train a classification network using the knowledge graphs possessed by the agent as an input value and the lower concept of the battlefield situation as a label, map the global knowledge graph to the lower concept of the battlefield situation through the classification network, and infer the higher concept from the lower concept in the battlefield situation hierarchical structure to recognize the battlefield situation.

According to another aspect of the present invention, a method of generating a knowledge graph includes collecting, by an agent, pieces of data, defining objects recognized from the data as nodes, defining a feature of the node as a property, and defining a predetermined relation between the nodes as a relation, training an embedding vector (vec1) related to the property of the node, training an embedding vector (vec3) related to the relation between the nodes, and then generating a node embedding vector by concatenating an embedding vector (vec2) in which a node name is defined with the vec1 and vec3, and generating an agent knowledge graph including the node, the relation, and the node embedding vector.

The embedding vector (vec1) related to the property of the node may be trained to be similar to a property vector directly related to the node, and dissimilar to a property vector not related to the node.

The embedding vector (vec3) may be trained in such a way that embedding vectors (vec3) of nodes having a relation to each other become similar.

According to another aspect of the present invention, a method of concatenating a knowledge graph includes generating a hypergraph including hypernodes (agents) and a hyperedge based on an agent knowledge graph including a node, a relation, and a node embedding vector, constructing a training data set for generating an agent list by sampling an agent that is the hypernode on the hypergraph, training an agent embedding vector to minimize a cost function using, as training data, an (agent, adjacent agent) pair derived by applying a context window to the agent list, inferring a similarity between the agents using the agent embedding vector, inferring a similarity between nodes of an agent knowledge graph using the agent embedding vector and a fixed vector (relation aware vector) assigned to each of the nodes of the agent knowledge graph, and generating a global knowledge graph by concatenating the knowledge graph based on the similarity between the agents and the similarity between the nodes (data similarity).

Each of the hypernodes may correspond to one of the agents, the hyperedge may include a set of agents adjacent to each of the nodes, and the adjacent agent may be determined according to a similarity between a node embedding vector of the node and a node embedding vector of a node included in the knowledge graph of the adjacent agent.

The agent list may be generated in a way to move an arbitrary agent according to a random walk rule based on the hypergraph, and the random walk rule may define a movement probability from a current agent to a next agent, and include a rule for determining the movement probability according to the number of hyperedges included in the hypergraph shared by an agent adjacent to the current agent and a previously visited agent.

The cost function may be defined for the (agent, adjacent agent) pair (i,j) according to the following equation.

$$Cost ( e \vert {e}_{j} , ) = - ( log σ ( {f}_{k} ( {e}_{i} ) \cdot {f}_{i} ( {e}_{j} ) - {c}_{k l} ) + {\sum }_{m ∈ {Ψ}_{f}} {\sum }_{v ∈ {Ψ}_{a}} log σ ( - {f}_{m} ( {e}_{v} ) \cdot {f}_{l} ( {e}_{j} ) + {c}_{ml} ) ) \qquad [ Equation 2 ]$$

(Here, in the above Equation, i,j, and v denote the agents,

k, l, and m denote nodes constructing the agent knowledge graph,

eᵢ, eⱼ, and eᵥ denote the agent embedding vectors,

uₖ, uₗ, and uₘ denote the fixed vectors (relation aware vector) assigned to the node,

c denotes a dot product of the relation aware vectors of each of the nodes written in a subscript,

Ψₐ denotes a set of agents, and Ψ_{f} denotes a set of nodes constructing the agent knowledge graph,

σ denotes a sigmoid function, and

f denotes a vector function that returns a sum of the relation aware vector of the node written in the subscript and the agent embedding vector as an argument).

According to an embodiment of the present invention, a method of inferring a battlefield situation includes defining a battlefield situation as a hierarchical structure composed of a higher concept and a lower concept, training a classification network by using knowledge graphs possessed by agents collecting data about the battlefield situation as an input value and the lower concept of the battlefield situation as a label, mapping a global knowledge graph, in which knowledge graphs of each of the agents is integrated, to the lower concept of the battlefield situation through the classification network, and inferring (recognizing) the battlefield situation by inferring the higher concept from the lower concept in the battlefield situation hierarchical structure.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a battlefield situation awareness system according to an embodiment of the present invention;

FIGS. 2A and 2B are block diagrams illustrating a configuration and a function of the battlefield situation awareness system according to the embodiment of the present invention;

FIG. 3 is a diagram for describing an operation concept of a knowledge graph generation unit of the battlefield situation awareness system according to the embodiment of the present invention;

FIG. 4 is a block diagram illustrating a configuration of a knowledge graph concatenation unit of the battlefield situation awareness system according to the embodiment of the present invention;

FIGS. 5A and 5B are diagrams for describing an operation concept of the knowledge graph concatenation unit of the battlefield situation awareness system according to the embodiment of the present invention;

FIG. 6 is a diagram illustrating a hypergraph incidence matrix according to an embodiment of the present invention;

FIG. 7 is a diagram illustrating a hypergraph according to an embodiment of the present invention;

FIG. 8 is a diagram for describing an operation concept of a relation aware vector sub-module and an agent embedding vector sub-module according to an embodiment of the present invention;

FIG. 9 is a diagram for describing an effect of a relation awareness vector for a cost function according to an embodiment of the present invention;

FIG. 10 is a diagram for describing an operation concept of a battlefield situation awareness unit of the battlefield situation awareness system according to the embodiment of the present invention;

FIG. 11 is a flowchart for describing a method of generating a knowledge graph according to an embodiment of the present invention;

FIG. 12 is a flowchart for describing a method of concatenating a knowledge graph according to an embodiment of the present invention; and

FIG. 13 is a flowchart illustrating a method of inferring a battlefield situation according to an embodiment of the present invention.

### DETAILED DESCRIPTION OF EXEMPLARY EMBODIMENTS

Various advantages and features of the present invention and methods accomplishing them will become apparent from the following description of embodiments with reference to the accompanying drawings. However, the present invention is not limited to exemplary embodiments to be described below, but may be implemented in various different forms, these exemplary embodiments will be provided only in order to make the present invention complete and allow those skilled in the art to completely recognize the scope of the present invention, and the present invention will be defined by the scope of the claims. Meanwhile, terms used in the present specification are for explaining exemplary embodiments rather than limiting the present invention. In the present invention, a singular form includes a plural form unless explicitly described to the contrary. Components, steps, operations, and/or elements described by the terms “comprise” and/or “comprising” used in the present invention do not exclude the existence or addition of one or more other components, steps, operations, and/or elements.

When it is decided that the detailed description of the known art related to the present invention may unnecessary obscure the gist of the present invention, a detailed description therefor will be omitted.

Hereinafter, embodiments of the present invention will be described in detail with reference to the accompanying drawings. The same means will be denoted by the same reference numerals throughout the accompanying drawings in order to facilitate the general understanding of the present invention in describing the present invention.

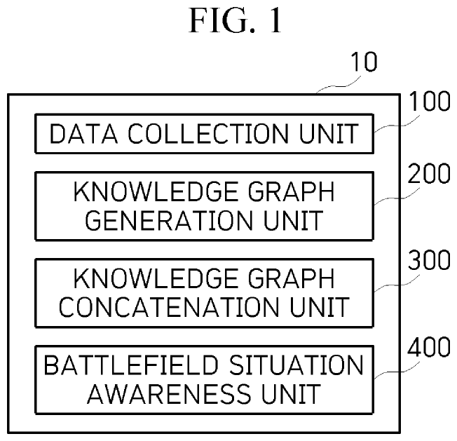

FIG. 1 is a block diagram illustrating a configuration of a battlefield situation awareness system 10 according to an embodiment of the present invention.

As illustrated in FIG. 1, the system 10 for hypergraph-based multi-agent battlefield situation awareness according to the embodiment of the present invention for achieving the above technical problem includes a data collection unit 100 that collects battlefield situation data through a plurality of agents, a knowledge graph generation unit 200 that receives multi-modal data collected by each agent and a scene graph corresponding to the multi-modal data as an input to generate knowledge graphs, a knowledge graph concatenation unit 300 that analyzes a similarity between agents and a similarity between pieces of data collected by adjacent agents using a hypergraph to concatenate the knowledge graphs, and a battlefield situation awareness unit 400 that infers a battlefield situation from the concatenated global knowledge graph.

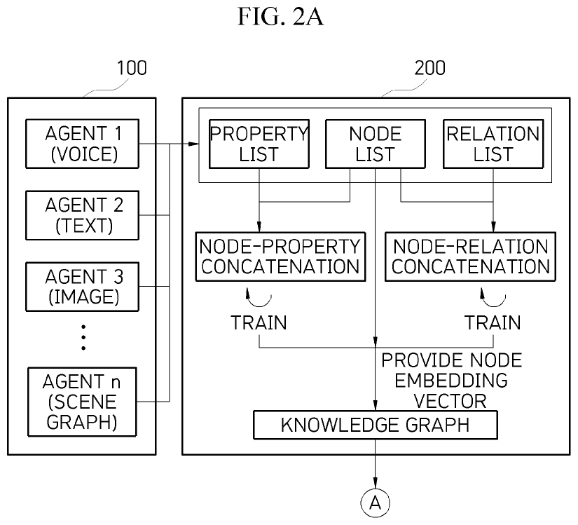

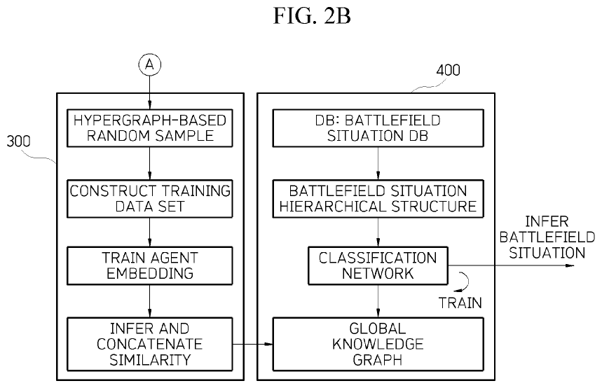

FIGS. 2A and 2B are block diagrams illustrating a configuration and function of the battlefield situation awareness system 10 according to an embodiment of the present invention.

The system for hypergraph-based multi-agent battlefield situation awareness according to the embodiment of the present invention is a deep learning system that may flexibly respond to a change in the number of agents (n), that is, has scalability. The data collected by the agent may include multi-modal data (visual, voice, language, etc.), meta-information, a scene graph, and the like. The data collected by the agent is not limited by the amount, type, or characteristics of data.

The knowledge graph generation unit 200 generates a node list by defining objects recognized from the pieces of data collected by each agent as nodes, defines the features of each node as a property to generate a property list, and defines a predetermined relation between the nodes as a relation to generate a relation list. In addition, the knowledge graph generation unit 200 concatenates the node and the property and trains an embedding vector vec1 so that the embedding vector vec1 is similar to a property (positive property) directly related to the node and dissimilar to a property (negative property) not related to the node. In addition, the knowledge graph generation unit 200 concatenates the node and the relation and trains embedding vectors vec3 so that the embedding vectors vec3 between adjacent nodes become similar. In addition, the knowledge graph generation unit 200 concatenates the embedding vector vec1, an embedding vector vec2 in which a node name is defined, and the embedding vector vec3 to generate node embedding vectors. The node embedding vector is assigned to each node and is a vector indicating the features of the node. The knowledge graph generation unit 200 constructs knowledge graphs (Hereinafter, abbreviated as agent knowledge graph. Unless otherwise specified, the “knowledge graph” means an agent knowledge graph) for each agent with nodes, node embedding vectors, and relations, and transmits the constructed knowledge graphs to the knowledge graph concatenation unit 300.

The knowledge graph concatenation unit 300 generates a hypergraph in which all agent knowledge graphs are integrated into one based on each agent knowledge graph, and samples adjacent agents through a random walk based on the hypergraph. As a result of the sampling, an agent list is generated. When all of the predetermined number of agent lists is generated, the set of agent lists is used as a training data set for training the agent embedding. In addition, the knowledge graph concatenation unit 300 derives an (agent, adjacent agent) pair from the predetermined number of agent lists (training data set) and trains the agent embedding vector to minimize a value of a cost function calculated from the (agent, adjacent agent) pair. The knowledge graph concatenation unit 300 infers a similarity between a plurality of agents and a similarity between pieces of data collected by adjacent agents through the agent embedding vector, and concatenates each agent knowledge graph according to the inference result to generate a global knowledge graph and transmit the generated global knowledge graph to the battlefield situation awareness unit 400.

The battlefield situation awareness unit 400 defines the battlefield situation as a hierarchical structure (battlefield situation hierarchical structure) from a higher concept of battlefield situation to a lower concept of a battlefield situation. In this case, the battlefield situation hierarchical structure is called through mapping to situation information stored in a battlefield situation database. The battlefield situation awareness unit 400 trains a classification network by using the knowledge graphs or agent knowledge graphs possessed by the plurality of agents as an input value and the lower concept of the battlefield situation as a label. When the training of the classification network is completed, the battlefield situation awareness unit 400 may map local information (knowledge graph) collected by each agent through the classification network or the global knowledge graph integrating the local information to the lower concept of the battlefield situation. In the battlefield situation hierarchical structure, the inference of the next higher concept from the lower concept is sequentially performed to infer the higher concept of level 1, thereby recognizing (inferring) the battlefield situation (global situation).

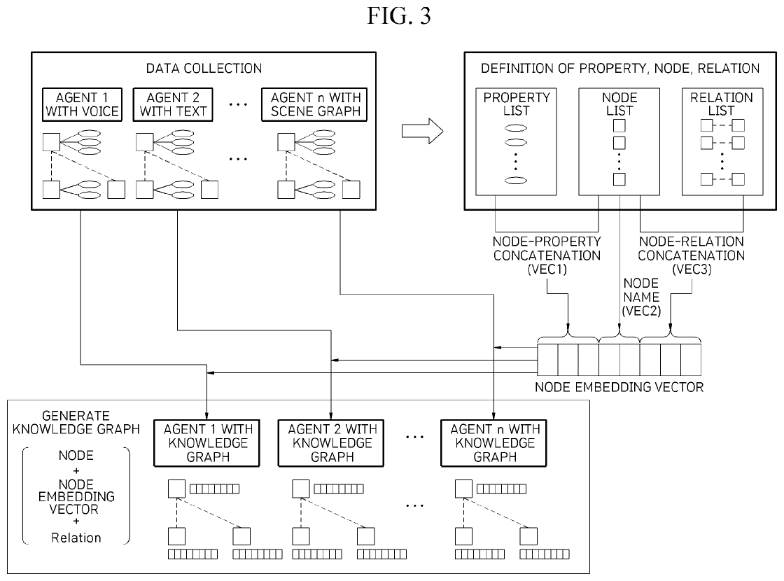

FIG. 3 is a diagram for describing an operation concept of the knowledge graph generation unit 200 of the battlefield situation awareness system according to the embodiment of the present invention.

The knowledge graph generation unit 200 defines an object recognized from data as a “node” and defines a feature of the node as a “property”, and defines a predetermined relation between nodes as the “relation” to process various types of data (visual, voice, language, meta-information, scene graph, etc.) collected by a plurality of agents.

For example, a node may be an object for data collection such as an armored motorcar, a person, a tree, a wall, or a road, and a property may be color, size, and state (movement/stationary), and a property value may be a code value assigned to each property. In addition, when there is a situation “the armored motorcar is stopped on a road”, a relation between the node “armored motorcar” and the “road” may be defined. However, the above-described contents are only examples of the node, property, and relation, and the scope of the node, property, and relation in the present invention is not limited to the above examples.

The knowledge graph generation unit 200 obtains a node list, a property list, and a relation list from the pieces of data collected by a plurality of agents. After obtaining the lists, the knowledge graph generation unit 200 trains the embedding vector vec1 expressing properties of each node and the embedding vector vec3 expressing a relation between each node. The knowledge graph generation unit 200 concatenates a node and a property through a node-property concatenation sub-module 201 and defines a property directly related to each node as a “positive property,” and a property not related to each node as a “negative property.” The knowledge graph generation unit 200 trains the embedding vector vec1 so that the embedding vector vec1 is similar to the positive property and dissimilar to the negative property through the node-property concatenation sub-module 201. In this case, the positive and negative properties are expressed as vectors, and it is preferable that a vector size of the embedding vector (vec1) and a vector size of the property are the same. In addition, the knowledge graph generation unit 200 trains the embedding vectors vec3 of each node so that the embedding vectors vec3 between adjacent nodes according to a graph structure become similar through the node-relation concatenation sub-module 202. Here, the nodes being adjacent means that there is a relation between the nodes, and the relation between the nodes is determined according to the relation list. The knowledge graph generation unit 200 generates a node embedding vector by concatenating the embedding vector vec2 and vec1 and vec3 in which the node name is defined. The knowledge graph generation unit 200 transfers the knowledge graph including the node, the node embedding vector, and the relation, to the knowledge graph concatenation unit 300.

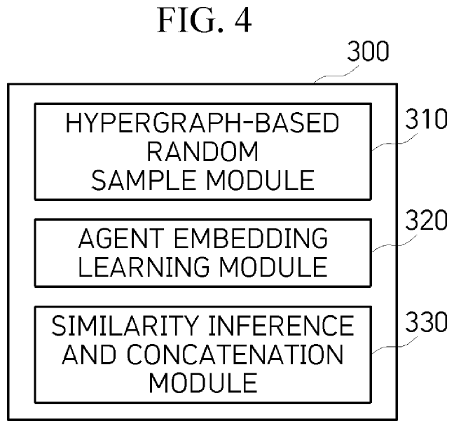

FIG. 4 is a block diagram illustrating a configuration of a knowledge graph concatenation unit 300 of a battlefield situation awareness system according to an embodiment of the present invention.

Referring to FIG. 4, the knowledge graph concatenation unit 300 of the battlefield situation awareness system according to the embodiment of the present invention includes a hypergraph-based random sample module 310, an agent embedding learning module 320, and a similarity inference and concatenation module 330. The hypergraph-based random sample module 310 generates a hypergraph in which all agent knowledge graphs are integrated into one based on the agent knowledge graph, and generates an agent list through sampling of adjacent agents based on the hypergraph. The agent embedding learning module 320 derives an (agent, adjacent agent) pair from the agent list and trains the agent embedding vector so that a value of a cost function calculated from the (agent, adjacent agent) pair is minimized. The similarity inference and concatenation module 330 determines a similarity between a plurality of agents using the agent embedding vector and concatenates each agent knowledge graph through an analysis of a similarity between data collected by adjacent agents to generate a global knowledge graph.

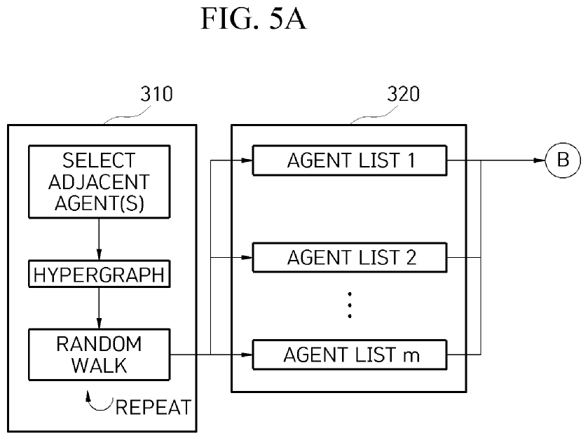

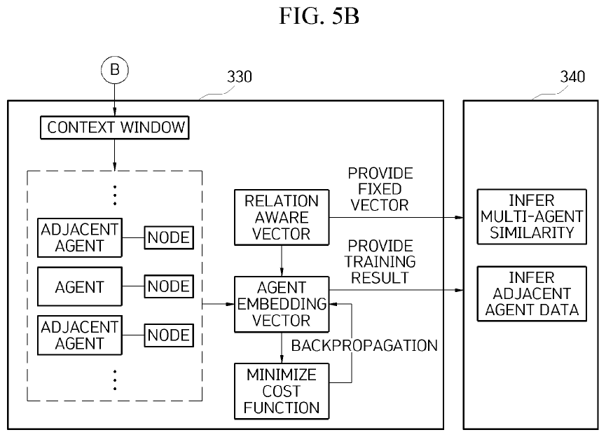

FIGS. 5A and 5B are diagrams for describing an operation concept of the knowledge graph concatenation unit 300 of the battlefield situation awareness system according to the embodiment of the present invention.

The hypergraph-based random sample module 310 includes an adjacent agent selection sub-module 311, a hypergraph sub-module 312, and a random walk sub-module 313.

The adjacent agent selection sub-module 311 selects adjacent agents based on each node included in each agent knowledge graph to construct a hypergraph incidence matrix (hereinafter, incidence matrix), the hypergraph sub-module 312 generates a hypergraph in which all agent knowledge graphs are integrated into one based on each agent knowledge graph according to the incidence matrix, and the random walk sub-module 313 samples adjacent agents according to predefined rules and strategies based on the hypergraph. The hypergraph-based random sample module 310 repeatedly executes the random walk sub-module 313 to generate m independent agent lists (agent sequences). Here, m represents a batch size of a data set required to train a deep learning network and is a natural number greater than or equal to one.

The agent embedding learning module 320 derives an (agent, adjacent agent) pair by sequentially applying a context window from the beginning to the end of a given agent list, and trains an agent embedding vector by using a relation aware vector sub-module 321 and an agent embedding vector sub-module 322 to minimize a cost function representing similarity between agents.

The similarity inference and concatenation module 330 includes a multi-agent similarity inference sub-module 331 that determines a similarity between a plurality of agents through the agent embedding vector provided by the agent embedding vector sub-module 322 and an adjacent agent data similarity inference sub-module 332 that determines a similarity between pieces of data collected by adjacent agents.

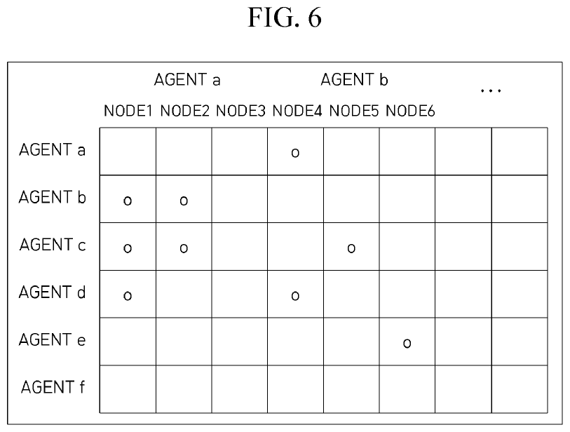

FIG. 6 is a diagram illustrating a hypergraph incidence matrix according to an embodiment of the present invention.

The adjacent agent selection sub-module 311 constructs an incidence matrix by selecting adjacent agents based on each node included in the agent knowledge graph (which may be a plurality of agent knowledge graphs), and a process of configuring the incidence matrix is as follows.

In an example of FIG. 6, for convenience of description, it is assumed that the incidence matrix is constructed based on only nodes (node 1, node 2, and node 3) belonging to a knowledge graph of ‘agent a’ and nodes (node 4, node 5, and node 6) belonging to a knowledge graph of ‘agent b’. However, in fact, it should be noted that the incidence matrix is constructed based on the nodes belonging to all agent knowledge graphs.

As illustrated in FIG. 6, the adjacent agent selection sub-module 311 searches for a node belonging to another agent knowledge graph similar to node 1. In this case, similarity between other nodes is determined using a node embedding vector of node 1, and the criterion for determining the similarity may be a cosine similarity or a Euclidean distance, and a threshold value depends on settings. As a result of determining, by the adjacent agent selection sub-module 311, the similarity between nodes based on the node embedding vector, an agent having the node similar to the node 1 in the knowledge graph is selected as an adjacent agent. There may be a plurality of nodes similar to the node 1, and there may also be a plurality of agents (adjacent agents) having nodes similar to the node 1 in the knowledge graph. In the example of FIG. 6, agent b, agent c, and agent d are selected as agents having the nodes similar to the node 1 in the knowledge graph. By repeating this process for each node, the incidence matrix may be constructed by selecting adjacent agents for each node. The method is to select an agent having a node having a similarity greater than or equal to a certain value with a reference node in the knowledge graph as an adjacent agent. As another embodiment of the present invention, when an average of similarities of nodes belonging to a specific agent knowledge graph with a reference node is greater than or equal to a certain value, a method of selecting the corresponding agent as an adjacent agent may be applied.

The hypergraph sub-module 312 generates a hypergraph in which each agent knowledge graph is integrated according to the incidence matrix. The hypergraph includes hypernodes and a hyperedge. Each agent corresponds to a hypernode. The hypernode has a meaning representing the agent knowledge graph of the corresponding agent. The hyperedge is generated based on the nodes of each agent knowledge graph. In the incidence matrix, an agent that is an agent adjacent to the node becomes a hypernode included in the corresponding hyperedge. Therefore, the hypergraph may be a graph, in which all agent knowledge graphs are integrated into one, and a graph that expresses adjacent information between agents. Meanwhile, the hyperedge may include one or more hypernodes. For example, three or more hypernodes may be included in one hyperedge. The hyperedge is constructed based on each node belonging to the knowledge graph in the agent. For example, the hypergraph sub-module 312 constructs hyperedge 1 based on the node 1. When following the incidence matrix of FIG. 6, adjacent agents based on the node 1 are agent b, agent c, and agent d. Accordingly, the hypernodes included in the hyperedge 1 become the agents b, c, and d, which are the adjacent agents based on the node 1, together with the agent a corresponding to the knowledge graph to which the node 1 belongs. Next, the hypergraph sub-module 312 constructs the hyperedge 2 based on the node 2, and the hypernode included in the hyperedge 2 becomes agents a, b, and c according to the example of FIG. 6. The hypergraph sub-module 312 may configure hyperedge 3 to hyperedge 6 in the same way as above. When the hyperedges for all nodes and the hypernodes included in each hyperedge are determined, the hypergraph is completed.

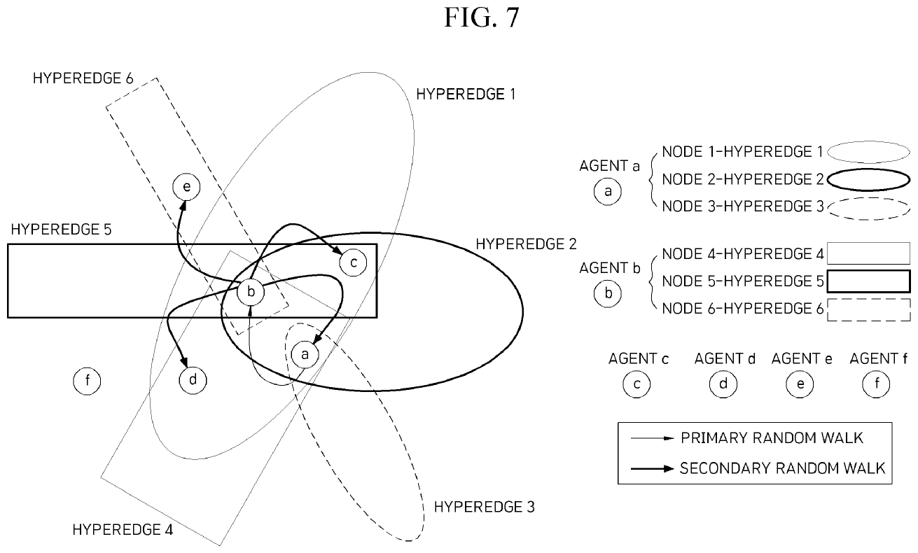

FIG. 7 is a diagram illustrating a hypergraph according to an embodiment of the present invention.

The hypergraph of FIG. 7 is generated based on the example of the incidence matrix of FIG. 6. As described above, the hypergraph includes the hypernode and the hyperedge. The hypernode represents an agent (i.e., agents a, b, c, d, e, and f). The hyperedge is generated based on the nodes constructing each agent knowledge graph. One hyperedge may include a plurality of hypernodes. For example, the hyperedge 1 generated based on the node 1 includes four hypernodes (agents a, b, c, and d). The hyperedge 2 generated based on the node 2 includes three hypernodes (agents a, b, and c). [Table 1] shows the results of generating a hypergraph (hyperedge and hypernode) based on each node of the agents a and b according to the example of the incidence matrix of FIG. 6. The agent of the hypernode represents the knowledge graph of the agent.

TABLE 1

| | | |
|---|---|---|
| Reference Node | Hyperedge | Hypernode (agent) |

| | | | |
|---|---|---|---|
| Agent a | Node 1 | Hyperedge 1 | a, b, c, d |
| | Node 2 | Hyperedge 2 | a, b, c |
| | Node 3 | Hyperedge 3 | a |
| Agent b | Node 4 | Hyperedge 4 | a, b, d |
| | Node 5 | Hyperedge 5 | b, c |
| | Node 6 | Hyperedge 6 | b, e |

When adjacent information between agents and data collected by a plurality of agents are integrated through the hypergraph, adjacent agents may be sampled through the random walk sub-module 313. Sampling an agent means generating a training data set composed of an agent list.

The random walk sub-module 313 samples an agent through the random walk. Hereinafter, random walk rules and strategies applied by the random walk sub-module 313 will be described.

In the present invention, the random walk means movement between hypernodes according to a rule based on a probabilistic model on a hypergraph. That is, the random walk means moving from a hypernode (agent) to another hypernode (agent) on the hypergraph according to the rule based on the probabilistic model. The random walk is divided into a primary random walk and a secondary random walk. The primary first random walk is applied to the first movement of the agent, and the secondary random walk is applied to the random walk (movement) after the primary random walk. The number of random walks depends on settings, but it is not limited. In other words, when sampling the agent with the random walk, the number of times the agent moves depends on the setting and is not limited. The size of the agent list is a value obtained by adding one to the number of times the agent moves (the number of random walks). A first agent in each agent list may be determined by selecting an arbitrary agent from among all agents. When the first agent is determined in each agent, the random walk is performed from the first agent to construct the agent list.

In the first random walk, for a current agent (the first agent in each agent list) having k adjacent agents, a method of moving to adjacent agents with a probability of 1/k may be applied.

The secondary random walk assigns classes to agents adjacent to the current agent, and the probability of moving from the current agent to the adjacent agent is determined accordingly. The classes of each adjacent agent are determined according to the number of hyperedges shared by the previously visited agent and the adjacent agents, which may be determined as shown in the following example. However, the number of classes and the number of shared hyperedges that serve as the standard may differ from the example.

Class 0: When the number of shared hyperedges=0

Class 1: When the number of shared hyperedges=1

Class 2: When the number of shared hyperedges≥2

The probability of moving to the corresponding adjacent agents according to each class is calculated by applying hyperparameters p and q, which may be determined as in the following example. p and q are real numbers greater than 0, and p+q is less than 1.

Adjacent agents belonging to class 0: move with a probability of (1-p-q)

Adjacent agents belonging to class 1: move with a probability of p

Adjacent agents belonging to class 2: move with a probability of q

In the random walk rule exemplified above, the probability of moving to the adjacent agents is controlled by the hyperparameters p and q. When the current agent moves from the current agent to the adjacent agents through the primary random walk, an agent candidate to visit next is determined through the secondary random walk. In this case, a next agent to move is determined through a class that considers a correlation between the adjacent agents and the previously visited agent. The agent sampling result is affected by the hyperparameters p and q. When the values of p and q are large, movement (local movement) is made to agents with many shared hyperedges, and when the values of p and q are small, movement (i.e., global movement) is made to an agent that has not been visited in the meantime. In the above random walk rule, the secondary random walk classifies an agent into three classes but can classify the agent into more classes or two classes and set and apply related hyperparameters.

In FIG. 7, the hyperedge is generated based on nodes 1, 2, and 3 included in the knowledge graph of the agent a and nodes 4, 5, and 6 included in the knowledge graph of the agent b, but this is a simplified example for convenience of explanation, and as described above, in reality, the hyperedge is additionally constructed based on nodes included in knowledge graphs of other agents.

Hereinafter, an example of sampling an agent according to the incidence matrix and the random walk in the hypergraph will be described with reference to FIGS. 6 and 7.

In the incidence matrix, each row denotes a hypernode (that is, an agent), each column denotes a hyperedge, and the hyperedge includes adjacent hypernodes selected through the adjacent agent selection sub-module 311. The random walk sub-module 313 provides a function of sampling agents adjacent to the incidence matrix through the primary and secondary random walk rules and strategies. In this example, the agent a is adjacent to the agents b, c, and d through the incidence matrix, and the agent b is adjacent to the agents a, c, d, and e. Therefore, when the first agent in the agent list is the agent a, it is possible to move from the agent a, which is the current agent, to any one of the agents b, c, and d, which are adjacent agents, through the primary random walk. When the movement is made to the agent b in the primary random walk, in the second random walk, the movement is made to any one of the adjacent agents a, c, d, and e of the agent b, which is the current agent, according to the hyperparameters p and q. In this case, the probability of moving to each adjacent agent a, c, d, and e is determined by considering a correlation between the agent a, which is the previous agent, and each adjacent agent.

For example, in the second random walk, the probability of moving from the agent b to the adjacent agent c considers the correlation between the previous agent a and the agent c. In this case, when the example of the rule of the above-described secondary random walk is applied, the movement probability is determined as follows. When referring to [Table 1], the hyperedge shared by the agent a and the agent c are hyperedge 1 and hyperedge 2. Therefore, since the number of hyperedges shared by the agent a and the agent c is two, the class assigned to the agent c is class 2. Given the hyperparameters p and q, the probability of moving to the agent of the class 2 is q, and thus the probability of moving from the agent b to the adjacent agent c in the second random walk becomes q. [Table 2] shows the probability of moving from the current agent b to each adjacent agent in the second random walk in this way.

TABLE 2

| | | | Hyperedge | | |
|---|---|---|---|---|---|
| | | | shared between | | |
| | | | previously | | Probability |
| Previously | | | visited agent | Class of | of moving |
| visited | Current | Adjacent | and adjacent | adjacent | to adjacent |
| agent | agent | agent | agent | class | agent |
| a | b | a | Hyperedge | 2 | q |
| | | | 1, 2, 3, 4 | | |
| | | c | Hyperedge 1, 2 | 2 | q |
| | | d | Hyperedge 1, 4 | 2 | q |
| | | e | None | 0 | 1-p-q |

The hypergraph-based random sample module 310 repeatedly executes the random walk sub-module 313 to derive m independent agent lists (agent sequences). The agent sequence is used as the training data set in the process of training the agent embedding vector in the agent embedding learning module 320.

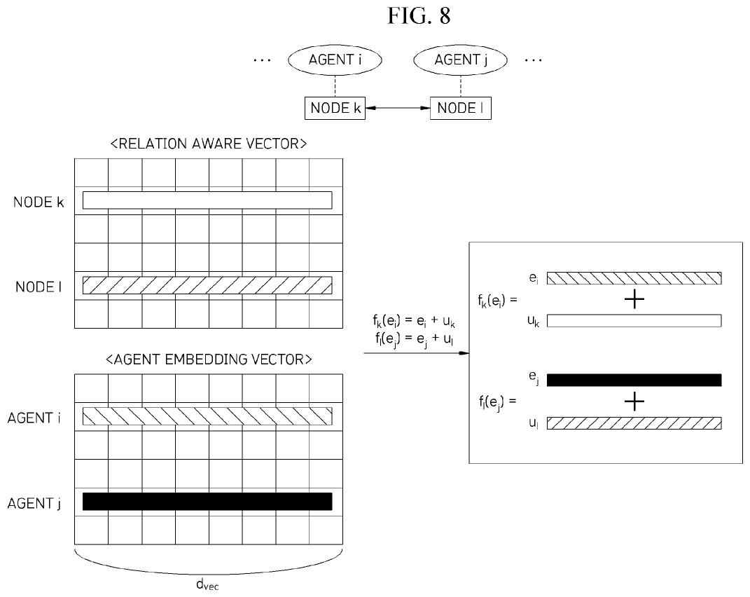

FIG. 8 is a diagram for describing an operation concept of the relation aware vector sub-module 321 and the agent embedding vector sub-module 322 included in the agent embedding learning module 320 according to an embodiment of the present invention.

The agent embedding learning module 320 applies a context window to each agent list in the agent sequence to obtain the (agent, adjacent agent) pair. A size of the context window is a natural number greater than or equal to one, but is not limited, and may vary according to settings. For example, given the agent list as (a,b,a,b,e), when context window size 2 is applied with a first a as a central agent, agents within the range from the first a to two-time random walk are considered adjacent agents, and thus the obtainable (agent, adjacent agent) pair becomes (a, b) In addition, when the context window size 2 is applied with a third a in the same agent list as a central agent, agents within the range from the third a to two-time random walk are considered adjacent agents, and thus the obtainable (agent, adjacent agent) pair become (a, b) and (a, e).

When the context window is applied to all agent lists and a set of (agent, adjacent agent) pairs is generated, the relation aware vector sub-module 321 and the agent embedding vector sub-module 322 used for training the agent embedding vectors of each agent operate. The relation aware vector sub-module 321 defines and assigns a fixed vector (relation aware vector) to nodes constructing knowledge graphs collected by a plurality of agents, that is, nodes that are a basis of each hyperedge, and the agent embedding vector sub-module 322 provides an agent embedding vector. The agent embedding vector sub-module 322 may train the agent embedding vector.

According to an embodiment of the present invention, for node k, which is one of nodes constructing a knowledge graph of agent i, a vector function fₖ that outputs a vector obtained by summing an agent embedding vector eᵢ and a relation aware vector uₖ assigned to the node k may be defined as in [Equation 1] below.

fₖ(eᵢ)=eᵢ+uₖ,iεΨₐ,kεΨ_{f} [Equation 1]

In [Equation 1], Ψₐ denotes a set of agents, Ψ_{f} denotes a set of nodes constructing knowledge graphs collected by a plurality of agents, eᵢ denotes an embedding vector assigned to agent i from the agent embedding vector sub-module 322, uₖ denotes a relation aware vector assigned to node k from the relation aware vector sub-module 321.

According to an embodiment of the present invention, the agent embedding learning module 320 utilizes the vectors fₖ(eᵢ) and fᵢ(eᵢ) obtained in [Equation 1] for the (agent, adjacent agent) pair (i,j) to calculate a cost function as in [Equation 2] below and trains a deep learning network through back propagation to generate an agent embedding vector. Through the agent embedding vector, agents placed in the same battlefield situation may be classified, and the similarity between the pieces of information acquired by the agents may be determined. The (agent, adjacent agent) pairs (i,j) used by the agent embedding learning module 320 are derived by applying a context window to the agent list as described above.

$$Cost ( e \vert {e}_{j} , {ψ}_{f} ) = - ( log σ ( {f}_{k} ( {e}_{i} ) \cdot {f}_{i} ( {e}_{j} ) - {c}_{k l} ) + {\sum }_{m ∈ {Ψ}_{f}} {\sum }_{v ∈ {Ψ}_{a}} log σ ( - {f}_{m} ( {e}_{v} ) \cdot {f}_{l} ( {e}_{j} ) + {c}_{ml} ) ) \qquad [ Equation 2 ]$$

(Here, in the above Equation, i,j, and v denote agents,

k, l, and m denote nodes constructing the agent knowledge graph,

eᵢ, eⱼ, and eᵥ denote the agent embedding vectors,

uₖ, uₗ, and uₘ denote the fixed vectors (relation aware vectors) assigned to the node,

c denotes a dot product of the relation aware vectors of each of the nodes written as a subscript,

Ψₐ is the set of agents,

Ψ_{f} is the set of nodes constructing the agent knowledge graph,

σ denotes a sigmoid function, and

f denotes a vector function that returns a sum of the relation aware vector of the node written in the subscript and the agent embedding vector as an argument).

[Equation 2] defines a cost function required for training a deep learning network in the agent embedding learning module 320. This example shows the cost function for the (agent, adjacent agent) pairs (i,j), where σ denotes a sigmoid function, cₖₗ=uₖ·uₗ. For the embedding vector eᵢ of agent j, the agent embedding vector eᵢ is trained so that the first term of [Equation 2], fₖ(eᵢ) and fᵢ(eᵢ) are similar in consideration of the adjacent agent i, and the second term of [Equation 2], fᵢ(eᵢ) and fₘ(eᵥ) without similarity (mεΨ_{f}) are different from each other. The cost function proposed in the present invention considers additional consideration of the fixed vector uₖ(kεΨ_{f}) provided by the relation aware vector sub-module 321, instead of the cost function (that is Cost(e|eⱼ)=—(log σ(eᵢ·eⱼ)+Σ_{νεΨ}_{ₐ} log σ(−e_{ν}·eⱼ))) which only considers agent embedding vector. Therefore, by applying the cost function, the agent embedding vector may be trained to recognize a relation between nodes constructing the knowledge graph. On the other hand, in an embodiment of the present invention, the cost function used by the agent embedding learning module 320 for training the deep learning network can basically select all agents and nodes as agent v and node m as shown in [Equation 2]. However, the agent embedding learning module 320 according to another embodiment of the present invention may derive the node m of the agent v without similarity to the node 1 of the agent j from the existing hypergraph incidence matrix in order to increase the training effect. That is, the agent embedding learning module 320 may train the deep learning network by selecting agents and nodes, which are not selected from the adjacent agent selection sub-module 311, as the agent v and the node m.

The relation aware vector uₖ(kεΨ_{f}) of the d_{vec}(>0) dimension may be defined according to [Equation 3] or [Equation 4]. [Equation 3] is a case of defining uₖ using a positional vector, and [Equation 4] is a case of defining uₖ using an orthonormal vector.

$${u}_{k} = {[ {u}_{k , 1} , {u}_{k , 2} , … , {u}_{k , 2 n - 1} , {u}_{k , 2 n} , … , {u}_{k , {d}_{v e c}} ]}^{T} , \qquad [ Equation 3 ]$$

$${u}_{k , 2 n - 1} = cos ( {( \frac{k}{\vert {Ψ}_{f} \vert} )}^{\frac{2 n - 1}{{d}_{vec}}} ) , {u}_{k , 2 n} = sin ( {( \frac{k}{\vert {Ψ}_{f} \vert} )}^{\frac{2 n - 1}{{d}_{vec}}} ) , for n = 1 , 2 , …$$

$${u}_{k} \cdot {u}_{l} = 0 for k \neq l with ‖ {u}_{k} ‖ = ‖ {u}_{l} ‖ = 1 , k , l ∈ {Ψ}_{f} \qquad [ Equation 4 ]$$

The relation aware vector sub-module 321 according to the embodiment of the present invention utilizes [Equation 3] or [Equation 4] to define the fixed relation aware vector assigned to the nodes constructing the knowledge graph collected by each agent.

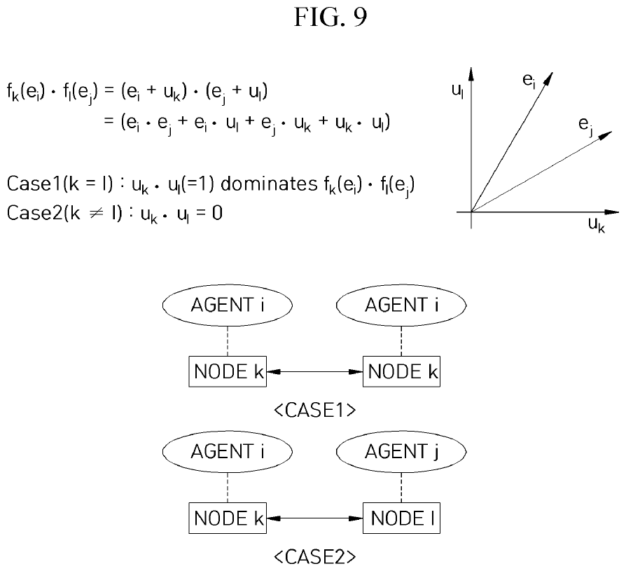

FIG. 9 is a diagram for describing an effect of a relation awareness vector for a cost function according to an embodiment of the present invention.

According to the present invention, it is possible to effectively train the agent embedding vector through the introduction of the relation aware vector. For example, in the cost function Cost(e|eⱼ,Ψ_{f}) defined in [Equation 2], fₖ(eᵢ) fₗ(eⱼ)=eᵢ·eⱼ+eᵢ·uₖ+eⱼ·uₗ+uₖ uₗ, and a value of fₖ(eᵢ)·fₗ(eⱼ) is affected by the relation aware vectors uₖ and uₗ. For example, when k and l are the same as in case 1 of FIG. 9, the value of uₖ·uₗ becomes 1, and thus the value of fₖ(eᵢ)·fₗ(eⱼ) is greatly affected (“dominated”). Therefore, in order to minimize the influence of the fixed relation-aware inter-vector dot product (cₖₗ=uₖ·uₗ) on the cost function, in the present invention, instead of fₖ(eᵢ)·fₗ(eⱼ), fₖ(eᵢ)·fₗ(eⱼ)−cₖₗ is applied to the cost function. In addition, in the case of using the orthonormal vector instead of the positional vector, since uₖ·uₗ=0 for k≠1 is satisfied, and since uₖ and uₗ are orthogonal, the agent embedding vectors eᵢ and eⱼ are trained well.

When the training of the agent embedding vector is completed, the agent embedding learning module 320 provides the trained agent embedding vector and the fixed relation aware vector to the similarity inference and concatenation module 330. The similarity inference and concatenation module 330 may use the agent embedding vector eᵢ(iεΨₐ) and the relation aware vector uₖ(kεΨ_{f}) to determine the similarity between agents and the similarity of data collected by the agents.

The multi-agent similarity inference sub-module 331 determines the similarity between agents i,j(εΨₐ) as cos_sim(eᵢ, eⱼ) or Eud(eᵢ, eⱼ). Agents placed in the same battlefield situation may be classified by determining the similarity between agents.

The adjacent agent data similarity inference sub-module 332 calculates the similarity between the node k constituting the knowledge graph of agent i and the node 1 constructing the knowledge graph of agent j as cos_sim(eᵢ+uₖ,eⱼ)+uₗ) or Eud(eᵢ+uₖ,eⱼ+uₗ), for the adjacent agents i,j. That is, the adjacent agent data similarity inference sub-module 332 determines the similarity between the pieces of data collected by the adjacent agents. Here, the “adjacent agent” indicates an agent inferred to be similar based on the similarity between agents determined by the multi-agent similarity inference sub-module 331.

cos_sim(x,y) represents a cosine similarity between vectors x and y, and Eud(x,y) represents a Euclidean distance between vectors x and y. The multi-agent similarity inference sub-module 331 infers a similarity between agents by using the agent embedding vector provided by the agent embedding vector sub-module 322. The adjacent agent data similarity inference sub-module 332 uses a vector in which the relation aware vector provided by the relation aware vector sub-module 321 and the agent embedding vector provided by the agent embedding vector sub-module 322 are concatenated to determine the similarity between the pieces of data collected by the agents.

The similarity inference and concatenation module 330 generates a global knowledge graph by concatenating the agent knowledge graph. A method of concatenating, by a similarity inference and concatenation module 330, agent knowledge graphs includes an agent-level concatenation and a node-level concatenation. The agent-level concatenation follows a method of constructing a global knowledge graph based on the similarity of agents, and the node-level concatenation follows a method of newly generating a relation between similar nodes when it is determined that nodes belonging to agent knowledge graphs of different agents are similar and repeating an operation in which two knowledge graphs are connected by a new relation to generate one integrated graph. In the case of the node-level concatenation, the similarity inference and concatenation module 330 analyzes a similarity between pieces of data collected by adjacent agents and concatenates agent knowledge graphs according to the similarity.

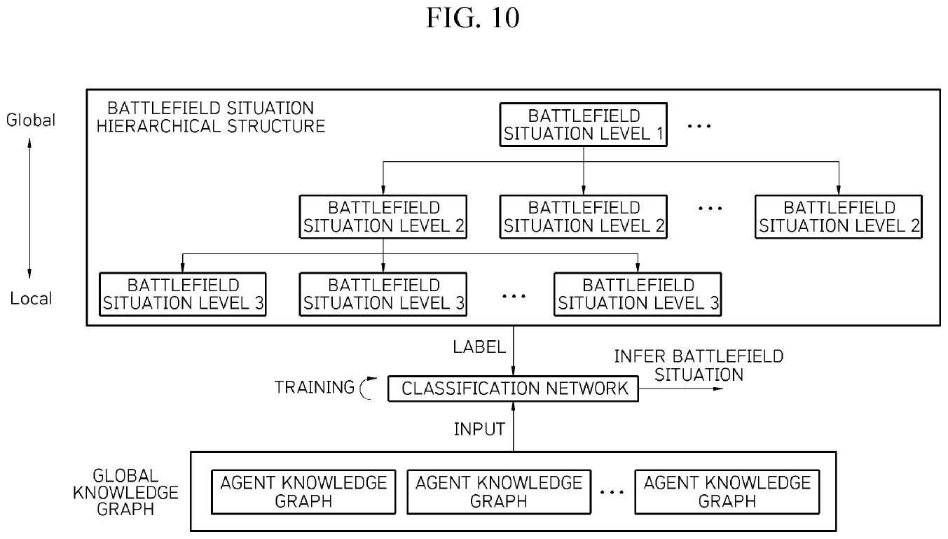

FIG. 10 is a view for describing an operation concept of the battlefield situation awareness unit 400 of the battlefield situation awareness system according to the embodiment of the present invention.

The battlefield situation hierarchical structure sub-module 401 defines the battlefield situation as a hierarchical structure (hierarchical symbol) from the higher concept of the battlefield situation to the lower concept of the battlefield situation. The higher concept of the battlefield situation may be inferred based on a number of related lower concepts. In other words, the hierarchical structure may be a way to define a higher-lower concept. For example, the battlefield situation hierarchical structure sub-module 401 may define the battlefield situation as a three-stage hierarchical structure from the highest concept of the battlefield situation of level 1 to the lowest concept of the battlefield situation of level 3.

Meanwhile, the battlefield situation hierarchical structure sub-module 401 may define the battlefield situation hierarchical structure in various ways. For example, the battlefield situation hierarchical structure sub-module 401 may define the battlefield situation on a symbolic or a military unit scale. As an example of defining a battlefield situation as the symbolic and inferring the battlefield situation, when three agents (“three agents” when an agent is a person) each recognize a lower concept (local situation) such as “a gunshot is heard,” “a tank is passing,” and “a fire has occurred,” the higher concept of the battlefield situation, “engagement” may be inferred by synthesizing the three pieces of information. For example, when the battlefield situation is defined as the military unit scale, the lower concept is each soldier's situation, and the higher concept is a situation of a battalion or a regiment. The method of defining a battlefield situation on a symbolic or military unit scale is only one example, and the battlefield situation hierarchical structure sub-module 401 is not limited thereto, and other methods may be used to define the battlefield situation hierarchical structure.

A second highest concept may be inferred from one or more lower concepts in the hierarchical structure defined by the battlefield situation hierarchical structure sub-module 401. The battlefield situation awareness unit 400 trains the classification network by using knowledge graphs possessed by a plurality of agents as an input value and the lower concept of the battlefield situation as a label. When the training of the classification network is completed, the battlefield situation awareness unit 400 may map local information (knowledge graph) collected by each agent or the global knowledge graph integrating the local information through the classification network to the lower concept of the battlefield situation. Which graph is mapped to the lower concept of the battlefield situation varies depending on how to define the lower concept of the battlefield situation and how to classify the level of the battlefield situation hierarchical structure. In the battlefield situation hierarchical structure, the inference of the next higher concept from the lower concept sequentially proceeds to infer the higher concept of level 1, thereby recognizing (inferring) the battlefield situation (global situation). Although the battlefield situation is classified into three stages in FIG. 10, the battlefield situation can be classified hierarchically in more detail, and the battlefield situation awareness unit 400 proposed in the present invention may be applied.

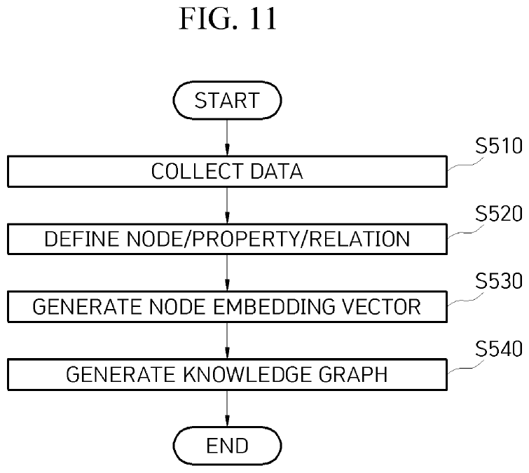

FIG. 11 is a flowchart for explaining a method of generating a knowledge graph according to an embodiment of the present invention.

Operation S510 is an operation of collecting data. Data collection is performed through an agent. The number of agents is one or more and may vary depending on the situation. Data collected by an agent may include multi-modal data (visual, voice, language, etc.), meta-information, a scene graph, and the like. The data collected by the agent is not limited by the amount, type, or characteristics of data.

Operation S520 is an operation of defining a node/property/relation. The knowledge graph generation unit 200 generates a node list by defining objects recognized from pieces of data collected by a plurality of agents as the nodes, defines the features of each node as the property to generate an attribute list, and defines a predetermined relation between the nodes as the relation to generate a relation list.

Operation S530 is an operation of generating a node embedding vector. The node embedding vector is generated for each node and is a vector representing the features of the node. The node embedding vector includes an embedding vector vec1 related to a property, an embedding vector vec2 in which a node name is defined, and an embedding vector vec3 related to a relation between nodes. The knowledge graph generation unit 200 defines a property directly related to each node as a “positive property” and an unrelated property as a “negative property.” The knowledge graph generation unit 200 trains the embedding vector vec1 so that the embedding vector vec1 is similar to the positive property and dissimilar to the negative property through the node-property concatenation sub-module 201. In this case, the positive and negative properties are expressed as vectors, and it is preferable that a vector size of the embedding vector vec1 and a vector size of the property are the same. In addition, the knowledge graph generation unit 200 trains the embedding vectors vec3 of each node so that the embedding vectors vec3 between adjacent nodes having a graph structure are similar through the node-relation concatenation sub-module 202. Here, the nodes being adjacent means that there is a relation between the nodes, and the relation between the nodes is determined according to the relation list. The knowledge graph generation unit 200 generates the node embedding vector by concatenating the vec1, vec2, and vec3.

Operation S540 is an operation of generating a knowledge graph. The knowledge graphs are generated for each agent that collects data. The knowledge graph generation unit 200 generates an agent knowledge graph including the node, the node embedding vector, and the relation.

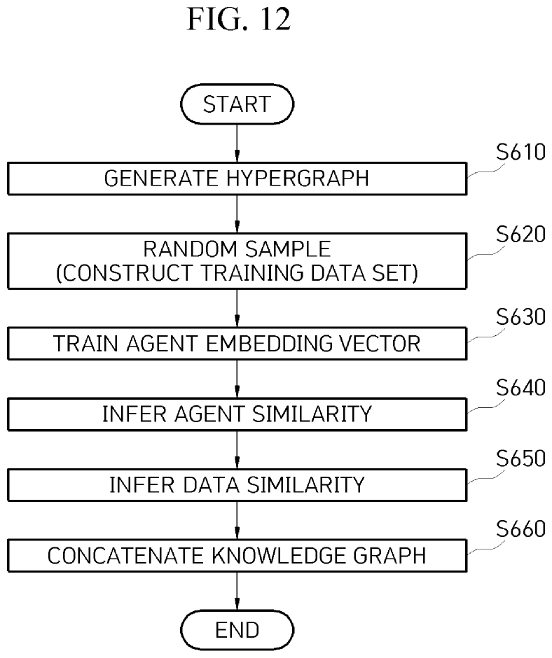

FIG. 12 is a flowchart for describing a method of concatenating a knowledge graph according to an embodiment of the present invention.

Operation S610 is an operation of generating a hypergraph based on a knowledge graph. The knowledge graph concatenation unit 300 selects adjacent agents based on each node included in the agent knowledge graph to construct a hypergraph incidence matrix (hereinafter, incidence matrix) and generates a hypergraph in which all agent knowledge graphs are integrated into one based on the agent knowledge graph according to the incidence matrix.

The knowledge graph concatenation unit 300 determines the similarity between each node (reference node) of the agent knowledge graph and a node belonging to a knowledge graph of another agent. The knowledge graph concatenation unit 300 determines a similarity between nodes using the node embedding vector, and the criterion may be a cosine similarity or a Euclidean distance, and the threshold value depends on setting. As a result of determining the similarity between the nodes, an agent having a node similar to the reference node in the knowledge graph is selected as the adjacent agent. The knowledge graph concatenation unit 300 may construct an incidence matrix by repeating this process for each node and selecting adjacent agents for each node.

The knowledge graph concatenation unit 300 generates a hypergraph in which each agent knowledge graph is integrated according to the incidence matrix. The hypergraph includes a hypernode and a hyperedge. One agent may be one hypernode, and in this case, the “agent” has a meaning representing the knowledge graph of the agent. Meanwhile, the hyperedge may include one or more hypernodes. That is, three or more hypernodes may also be included in one hyperedge. The hyperedge is constructed based on each node belonging to the knowledge graph in the agent. In the incidence matrix, an agent (“adjacent agent”) having a node similar to a reference node as a component of the knowledge graph becomes a hypernode included in the hyperedge. That is, an agent having a node similar to the node that is the reference of the hyperedge as a component of the knowledge graph becomes the hypernode of the corresponding hyperedge. The knowledge graph concatenation unit 300 completes (generates) the hypergraph by determining the hyperedges for all nodes and the hypernodes included in each hyperedge.

Operation S620 is an operation of constructing a training data set by randomly sampling an agent based on the hypergraph.

The knowledge graph concatenation unit 300 generates m independent agent lists (agent sequences) by sampling adjacent agents according to predefined rules and strategies (random walk rules and strategies) based on the hypergraph. The adjacent agents are based on the incidence matrix. Here, m represents a batch size of a data set required to train a deep learning network, and is a natural number greater than or equal to one. The knowledge graph concatenation unit 300 starts from an arbitrary hypernode (agent) on the hypergraph and repeats moving to another hypernode (agent) according to the probabilistic model and the set number of movement in order to sample the adjacent agent, thereby generating an agent list. The random walk rules and strategies have been exemplified in the description with reference to FIG. 7.

The m independent agent lists (agent sequences) generated in the above manner are used in the operation of training the agent embedding vector.

Operation S630 is an operation for training the agent embedding vector. The knowledge graph concatenation unit 300 sequentially applies a context window from the beginning to the end of a given agent list to derive a (agent, adjacent agent) pair, and trains the agent embedding vector by using the (agent, adjacent agent) pair as training data to minimize the cost function. The deep learning may be applied for the training of the agent embedding vector.

The cost function is calculated using the inner product of the vector. Only the agent embedding vector may be applied to the dot product, but the vector function value that adds the relation aware vector, which is a fixed vector assigned to each node, to the agent embedding vector is preferably applied to the dot product. [Equation 1] is an example of the vector function, and [Equation 2] is an example of the cost function. [Equation 1] and [Equation 2] have been described above with reference to FIG. 8. The definition of the relation aware vector may be according to [Equation 3] or [Equation 4].

Operation S640 is an operation of inferring a similarity between agents.

The knowledge graph concatenation unit 300 infers (discriminates) a similarity between the agent i and the agent j through the agent embedding vector operation of each agent. The similarity may be inferred (distinguished) from the a cosine similarity or Euclidean distance between the agent embedding vector of the agent i and the agent embedding vector of the agent j. Agents placed in the same battlefield situation may be classified by determining the similarity between agents.

Operation S650 is an operation of inferring a data similarity between adjacent agents.

The knowledge graph concatenation unit 300 infers (discriminates) the similarity between the node k, which is a knowledge graph component of the agent i, and the node 1, which is a knowledge graph component of the agent j, with respect to the agent i and the agent j, which are adjacent agents. When the agent embedding vector of the agent i is the relation aware vector of the node k that is the knowledge graph component of the agent i is uₖ, the agent embedding vector of the agent j is eⱼ, and the relation aware vector of the node 1 that is the knowledge graph component of the agent j is uₗ, the data similarity (similarity between nodes) may be inferred (distinguished) by cos_sim(eᵢ+uₖ,eⱼ+uₗ) or Eud(eᵢ+uₖ,eⱼ+uₗ).

Operation S660 is an operation of generating the global knowledge graph by concatenating the knowledge graphs.

The knowledge graph concatenation unit 300 generates the global knowledge graph by concatenating the agent knowledge graphs based on the similarity between the agents and the data similarity (similarity between nodes).

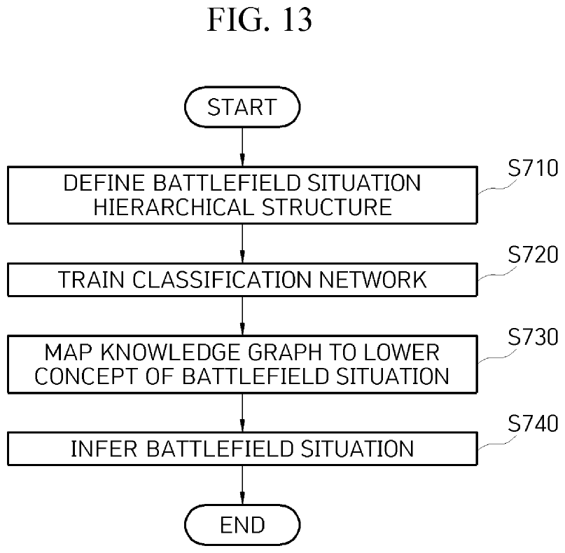

FIG. 13 is a flowchart illustrating a method of inferring a battlefield situation according to an embodiment of the present invention.

Operation S710 is an operation of defining a battlefield situation hierarchical structure. The battlefield situation awareness unit 400 defines the battlefield situation as the hierarchical structure from the higher concept of the battlefield situation to the lower concept of the battlefield situation. For example, the battlefield situation hierarchical structure sub-module 401 may define the battlefield situation as a three-stage hierarchical structure from the highest concept of the battlefield situation of level 1 to the lowest concept of the battlefield situation of level 3.

Operation S720 is an operation of training the classification network. The battlefield situation awareness unit 400 trains the classification network by using knowledge graphs or an agent knowledge graph possessed by a plurality of agents as an input value and the lower concept of the battlefield situation as a label.

Operation S730 is an operation of mapping the knowledge graph to the lower field of the battlefield situation. When the training of the classification network is completed, the battlefield situation awareness unit 400 maps the global knowledge graph to the lower concept of the battlefield situation. That is, the lower concept of the battlefield situation hierarchical structure defined above is derived by inputting the global knowledge graph to the classification network.

Operation S740 is an operation of inferring the battlefield situation. By inferring the higher concept of the hierarchical structure from the derived lower concept, the battlefield situation may be determined (the global situation may be recognized).

For reference, the components according to the embodiment of the present invention may be implemented in the form of software or hardware such as field programmable gate array (FPGA) or application specific integrated circuit (ASIC), and perform predetermined roles.

However, “components” are not limited to software or hardware, and each component may be configured to be in an addressable storage medium or to reproduce one or more processors.

Accordingly, for example, the component includes components such as software components, object-oriented software components, class components, and task components, processors, functions, properties, procedures, subroutines, segments of a program code, drivers, firmware, a microcode, a circuit, data, a database, data structures, tables, arrays, and variables.

Components and functions provided within the components may be concatenated into a smaller number of components or further divided into additional components.

In this case, it will be appreciated that each block of a processing flowchart and combinations of the flowcharts may be executed by computer program instructions. Since these computer program instructions may be installed in a processor of a general computer, a special computer, or other programmable data processing apparatuses, these computer program instructions executed through the process of the computer or the other programmable data processing apparatuses create means for performing functions described in a block (s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including instruction means for performing the functions described in the block(s) of the flowchart. Since the computer program instructions may also be installed in the computer or the other programmable data processing apparatuses, the instructions performing a series of operation steps on the computer or the other programmable data processing apparatuses to create processes executed by the computer, thereby executing the computer or the other programmable data processing apparatuses, may also provide steps for performing the functions described in a block(s) of the flowchart.

In addition, each block may indicate some of modules, segments, or codes including one or more executable instructions for executing a specific logical function (specific logical functions). Further, it is to be noted that functions described in the blocks occur regardless of a sequence in some alternative embodiments. For example, two blocks that are consecutively illustrated may be simultaneously performed in fact or be performed in a reverse sequence depending on corresponding functions.

In this case, the term “˜ unit” used in the present embodiment means software or hardware components such as an FPGA or ASIC, and “˜ unit” performs certain roles. However, the “unit” is not meant to be limited to software or hardware. The “˜unit” may be configured to be stored in a storage medium that can be addressed or may be configured to regenerate one or more processors. Accordingly, as an example, the “˜unit” refers to components such as software components, object-oriented software components, class components, and task components, processes, functions, properties, procedures, subroutines, segments of program code, drivers, firmware, microcode, circuits, data, databases, data structures, tables, arrays, and variables. Components and functions provided within “˜unit” may be combined into a smaller number of components and “˜unit” or may be further separated into additional components and “˜unit.” In addition, components and “˜ units” may be implemented to play one or more computer processing units (CPUs) in a device or a secure multimedia card.

The above-described method of generating a knowledge graph, a method of concatenating a knowledge graph, and battlefield situation awareness method have been described with reference to the flowchart presented in the drawings. For simplicity, the method has been illustrated and described as a series of blocks, but the invention is not limited to the order of the blocks, and some blocks may occur with other blocks in a different order or at the same time as illustrated and described in the present specification. Also, various other branches, flow paths, and orders of blocks that achieve the same or similar result may be implemented. In addition, all of the illustrated blocks may be not required for implementation of the methods described in the present specification.

According to an embodiment of the present invention, the present invention provides an unsupervised learning system and may use data (visual, voice, language, graph, etc.) or meta-information collected by agents to automatically generate embedding vectors (agent embedding vectors) representing characteristics of the agents, thereby analyzing similarity of information acquired by the agents.

According to an embodiment of the present invention, the present invention may provide a deep learning network that infers a battlefield situation through an analysis of a similarity of information to support regiment/division/corps-level global battlefield situation awareness that processes information collected by numerous agents, and global battlefield environment awareness, threat judgment, and command decision of commanders in the future battle environment where manned/unmanned agents are expected to play an active role.

Hereinabove, although the configuration of the present invention has been described in detail with reference to the accompanying drawings, this is merely an example, and those skilled in the art to which the present invention pertains can make various modifications and changes within the scope of the technical spirit of the present invention. Therefore, the protection scope of the present invention should not be limited to the above-described embodiments and should be defined by the description of the following claims.

What is claimed is:

1. A system for hypergraph-based multi-agent battlefield situation awareness, comprising:
a knowledge graph generation unit configured to receive pieces of data collected by agents as an input and generate agent knowledge graphs including nodes, relations, and node embedding vectors for each agent;
a knowledge graph concatenation unit configured to analyze a similarity between the respective agents and a similarity between pieces of data and concatenate the plurality of agent knowledge graphs to generate a global knowledge graph; and
a battlefield situation awareness unit configured to infer a battlefield situation using a battlefield situation hierarchical structure and the global knowledge graph.

2. The system of claim 1, wherein the knowledge graph generation unit defines an object, which is recognized from the data collected by the agent, as the node to generate a node list, defines features of the respective nodes as a property to generate a property list, and defines a predetermined relation between the nodes as the relation to generate a relation list.

3. The system of claim 1, wherein the knowledge graph generation unit generates the node embedding vector by concatenating an embedding vector (vec1) related to the property of the node, an embedding vector (vec2) in which a node name is defined, and an embedding vector (vec3) related to the relation between the nodes,
trains the embedding vector (vec1) so that the embedding vector (vec1) is similar to a property vector directly related to each of the nodes and dissimilar to a property vector not related to each of the nodes, and
trains the embedding vector (vec3) so that embedding vectors (vec3) of the nodes having the relation to each other become similar.

4. The system of claim 1, wherein the knowledge graph concatenation unit constructs an incidence matrix in a way to select an agent adjacent to a node of a specific agent knowledge graph, and
the adjacent agent includes a node having a node embedding vector similar to the node embedding vector of the node as a component of the agent knowledge graph.

5. The system of claim 1, wherein the knowledge graph concatenation unit includes:
a hypergraph-based random sample module configured to generate a hypergraph including hypernodes corresponding to each of the agents and hyperedges representing a set of adjacent agents of each of the nodes, and generate an agent list based on the hypergraph;
an agent embedding learning module configured to derive an (agent, adjacent agent) pair by applying a context window to the agent list, and train the agent embedding vector so that a value of a cost function calculated from the (agent, adjacent agent) pair is minimized; and
a similarity inference and concatenation module configured to generate the global knowledge graph by concatenating each agent knowledge graph through the analysis of the similarity between the agents using the agent embedding vector and an analysis of a similarity between data of a specific agent and data collected by an agent adjacent to the specific agent using the agent embedding vector.

6. The system of claim 5, wherein the hypergraph-based random sample module generates a hyperedge including a plurality of agents based on a similarity between the node embedding vectors assigned to each node of the agent knowledge graph and a node embedding vector of another agent knowledge graph, and generates a hypergraph including the hyperedge and a hypernode corresponding to an agent included in the hyperedge.

7. The system of claim 5, wherein the hypergraph-based random sample module generates the agent list in a way to move an arbitrary agent according to a random walk rule based on the hypergraph, and
the random walk rule defines a movement probability from a current agent to a next agent and includes a rule for determining the movement probability according to the number of hyperedges included in the hypergraph shared by an agent adjacent to the current agent and a previously visited agent.

8. The system of claim 5, wherein the cost function is defined for the (agent, adjacent agent) pair (i,j) according to the following Equation:
$$Cost ( e \vert {e}_{j} , {ψ}_{f} ) = - ( log σ ( {f}_{k} ( {e}_{i} ) \cdot {f}_{i} ( {e}_{j} ) - {c}_{k l} ) + {\sum }_{m ∈ {Ψ}_{f}} {\sum }_{v ∈ {Ψ}_{a}} log σ ( - {f}_{m} ( {e}_{v} ) \cdot {f}_{l} ( {e}_{j} ) + {c}_{ml} ) ) , \qquad [ Equation ]$$
(here, in the above Equation, i, j, and v denote the agents,
k, l, and m denote nodes constructing the agent knowledge graph,
eᵢ, eⱼ, and eᵥ denote the agent embedding vectors,
uₖ, uₗ, and uₘ denote the fixed vectors (relation aware vector) assigned to the node,
c denotes a dot product of the relation aware vectors of each of the nodes written in a subscript,
Ψₐ denotes a set of agents, and Ψ_{f} denotes a set of nodes constructing the agent knowledge graph,
σ denotes a sigmoid function, and
f denotes a vector function that returns a sum of the relation aware vector of the node written in the subscript and the agent embedding vector as an argument).

9. The system of claim 8, wherein the relation aware vector for an arbitrary knowledge graph node k is defined as uₖ=[U_{k,1}, U_{k,2}, . . . , U_{k,2n-1}, u_{k,2n}, . . . , U_{k,d}_{_{vec}}]^{T}, and
an arbitrary factor of uₖ is defined as
$${u}_{k , 2 n - 1} = cos ( {( \frac{k}{\vert {Ψ}_{f} \vert} )}^{\frac{2 n - 1}{{d}_{vec}}} ) , {u}_{k , 2 n} = sin ( {( \frac{k}{\vert {Ψ}_{f} \vert} )}^{\frac{2 n - 1}{{d}_{vec}}} ) , for n = 1 , 2 , … ,$$
(here, in the above Equation, d_{vec} denotes a dimension of uₖ).

10. The system of claim 8, wherein the relation aware vector for an arbitrary knowledge graph node k is
uₖuₗ=0 for k≠l with ∥uₖ∥=∥uᵢ∥=1,k,lεΨ_{f}.

11. The system of claim 1, wherein the battlefield situation awareness unit defines the battlefield situation as a hierarchical structure composed of a higher concept and a lower concept,
trains a classification network using the knowledge graph possessed by the agent as an input value and the lower concept of the battlefield situation as a label,
maps the global knowledge graph to the lower concept of the battlefield situation through the classification network, and
infers the higher concept from the lower concept in the battlefield situation hierarchical structure to recognize the battlefield situation.

12. A method of generating a knowledge graph, comprising:
collecting, by an agent, pieces of data;
defining objects recognized from the data as nodes, defining a feature of the node as a property, and defining a predetermined relation between the nodes as a relation;
training an embedding vector (vec1) related to the property of the node, training an embedding vector (vec3) related to the relation between the nodes, and then generating a node embedding vector by concatenating an embedding vector (vec2) in which a node name is defined with the vec1 and vec3; and
generating an agent knowledge graph including the nodes, the relation, and the node embedding vectors.

13. The method of claim 12, wherein the embedding vector (vec1) related to the property of the node is trained to be similar to a property vector directly related to the node and dissimilar to a property vector not related to the node.

14. The method of claim 12, wherein the embedding vector (vec3) is trained in such a way that embedding vectors (vec3) of nodes having a relation to each other become similar.

15. A method of concatenating a knowledge graph, comprising:
generating a hypergraph including hypernodes (agents) and a hyperedge based on an agent knowledge graph including nodes, relations, and node embedding vectors;
constructing a training data set for generating an agent list by sampling an agent that is the hypernode on the hypergraph;
training an agent embedding vector to minimize a cost function using, as training data, an (agent, adjacent agent) pair derived by applying a context window to the agent list;
inferring a similarity between the agents using the agent embedding vector;
inferring a similarity between the nodes of the agent knowledge graph using the agent embedding vector and a fixed vector (relation aware vector) assigned to each of the nodes of the agent knowledge graph; and
generating a global knowledge graph by concatenating the knowledge graph based on the similarity between the agents and the similarity between the nodes (data similarity).

16. The method of claim 15, wherein each of the hypernodes corresponds to one of the agents,
the hyperedge includes a set of agents adjacent to each of the nodes, and
the adjacent agent is determined according to a similarity between a node embedding vector of the node and a node embedding vector of a node included in the knowledge graph of the adjacent agent.

17. The method of claim 15, wherein the agent list is generated in a way to move an arbitrary agent according to a random walk rule based on the hypergraph, and
the random walk rule defines a movement probability from a current agent to a next agent, and includes a rule for determining the movement probability according to the number of hyperedges included in the hypergraph shared by an agent adjacent to the current agent and a previously visited agent.

18. The method of claim 15, wherein the cost function is defined for the (agent, adjacent agent) pair (i,j) according to the following equation:
$$Cost ( e \vert {e}_{j} , {ψ}_{f} ) = - ( log σ ( {f}_{k} ( {e}_{i} ) \cdot {f}_{i} ( {e}_{j} ) - {c}_{k l} ) + {\sum }_{m ∈ {Ψ}_{f}} {\sum }_{v ∈ {Ψ}_{a}} log σ ( - {f}_{m} ( {e}_{v} ) \cdot {f}_{l} ( {e}_{j} ) + {c}_{ml} ) ) , \qquad [ Equation ]$$
(here, in the above Equation, i, j, and v denote the agents,
k, 1, and m denote nodes constructing the agent knowledge graph,
eᵢ, eⱼ, and eᵥ denote the agent embedding vectors,
uₖ, uₗ, and uₘ denote the fixed vectors (relation aware vector) assigned to the node,
c denotes a dot product of the relation aware vectors of each of the nodes written in a subscript,
Ψₐ denotes a set of agents, and Ψ_{f} denotes a set of nodes constructing the agent knowledge graph,
σ denotes a sigmoid function, and
f denotes a vector function that returns a sum of the relation aware vector of the node written in the subscript and the agent embedding vector as an argument).
